(19) United States
(12) Patent Application Publication
(10) Pub. No.: US 2005/0117259 A1
(43) Pub. Date: Jun. 2, 2005

(54) Magnetic disc apparatus and assembling method of the same

(76) Inventors: Kouki Uefune, Odawara (JP); Takako Hayakawa, Hiratsuka (JP); Kenji Suzuki, Chiyoda (JP); Osamu Beppu, Oiso (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/701,628

(22) Filed: Nov. 6, 2003

(30) Foreign Application Priority Data
Nov. 8, 2002 (JP) 2002-324659

(51) Int. Cl. G11B 5/55

(52) U.S. Cl. 360/265.2

(57) ABSTRACT

In a magnetic disc apparatus, it is hard to fix a pivot mechanism in a carriage, in view of a mounting space, and in the case that a casing is made of resin, it is hard to fix in accordance with a conventional screwing method in view of a rigidity and a strength. A pivot mechanism (107) is fixed to a base (100) by press fitting a plastically deformable pivot pin (108) of the pivot mechanism (107) to the base (100), passing the pivot pin (108) through a sleeve (107-a) of the pivot mechanism (107) and plastically deforming the pivot pin (108). In the case of dissembling, the pivot pin (108) is pushed out from the base (100) together with a carriage (104), and thereafter the pivot pin (108) is separated from the pivot mechanism (107). Only the pivot pin (108) is disposable.

### BACKGROUND OF THE INVENTION

1. Field of the Invention

The present invention relates to a magnetic disc apparatus provided with a rotating carriage.

2. Description of the Prior Art

There has been conventionally described a magnetic disc apparatus provided with a fixed pivot shaft fixed to a base frame and having an outer peripheral surface on which a male screw is formed, a rotary pivot shaft having a female screw forming a pair together with the male screw formed in the fixed pivot shaft and screwed to the fixed pivot shaft, a bearing in which an inner ring is fixed to the outer periphery of the rotary pivot shaft by means of an adhesion, a press fitting or the like, a housing fixed to the outer ring of the bearing by means of the adhesion, the press fitting or the like, an actuator arm fixed to the housing and rotatably held via the bearing, a magnetic head supported and fixed to one end of the actuator arm via a suspension and recording and reproducing an information on and from a magnetic disc medium, and a coil fixed to another end of the actuator arm and constituting a part of a voice coil motor (for example, refer to JP-A-2000-207852).

Further, this patent document describes that since the rotary pivot shaft descends while rotating around the fixed pivot shaft, a lower surface of the rotary-pivot shaft is brought into contact with a positioning block formed in a part of the fixed pivot shaft, and the rotary pivot shaft is pressure contacted with the positioning block, it is possible to remove a play caused by a clearance of the screw pair between the rotary pivot shaft and the fixed pivot shaft, and the rotary pivot shaft is in a state in which the rotary pivot shaft is fixed to the base frame.

In the conventional apparatus, since the screw is formed on an inner peripheral surface of the rotary pivot shaft and the outer peripheral surface of the fixed pivot shaft, these surfaces can not be set as a reference surface for improving a concentricity and a perpendicularity, that is, a coaxiality.

The conventional apparatus is provided with a reference surface for securing the perpendicularity (preventing a slant) in the positioning block formed in the fixed pivot shaft which is brought into contact with the lower surface of the rotary pivot shaft. However, the more compact the apparatus is made, the harder it is to secure the reference in a direction of preventing the shaft from slanting. Further, the reference surface in the conventional apparatus can not be a reference surface for coaxially arranging the rotary pivot shaft with the fixed pivot shaft.

### SUMMARY OF THE INVENTION

An object of the present invention is to provide a magnetic disc apparatus which can position a carriage rotatably supporting a magnetic head and can be made compact, and an assembling method of the same.

Another object of the present invention is to provide a magnetic disc apparatus in which the magnetic head can be replaced, and an assembling method of the same, in addition to the object mentioned above.

An outer peripheral surface of a shaft fixed to a casing is pressed against an inner peripheral surface of a sleeve to which the shaft is inserted, from a side of an axis of the shaft, and the shaft and the sleeve are fixed. Accordingly, it is unnecessary to secure a thickness of a seat surface portion in the screw, in comparison with the screwing system. Further, accordingly, it is easy to secure a base thickness of a pivot fastening portion.

Further, the magnetic head can be replaced by taking out the shaft from the casing in a state in which the magnetic head is assembled in the sleeve.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross sectional view of a magnetic disc apparatus in accordance with an embodiment of the present invention;

FIG. 2 is an enlarged cross sectional view at a time of assembling a carriage portion of the magnetic disc apparatus in accordance with the embodiment of the present invention;

FIG. 3 is an enlarged cross sectional view of the carriage portion of the magnetic disc apparatus in accordance with the embodiment of the present invention;

FIG. 4 is an enlarged cross sectional view of the carriage portion of the magnetic disc apparatus in accordance with the embodiment of the present invention; and

FIG. 5 is an enlarged cross sectional view of the carriage portion showing a time of repairing the magnetic disc apparatus in accordance with the embodiment of the present invention.

### DESCRIPTION OF THE PREFERRED EMBODIMENT

A description will be given below of an embodiment in accordance with the present invention with reference to the accompanying drawings.

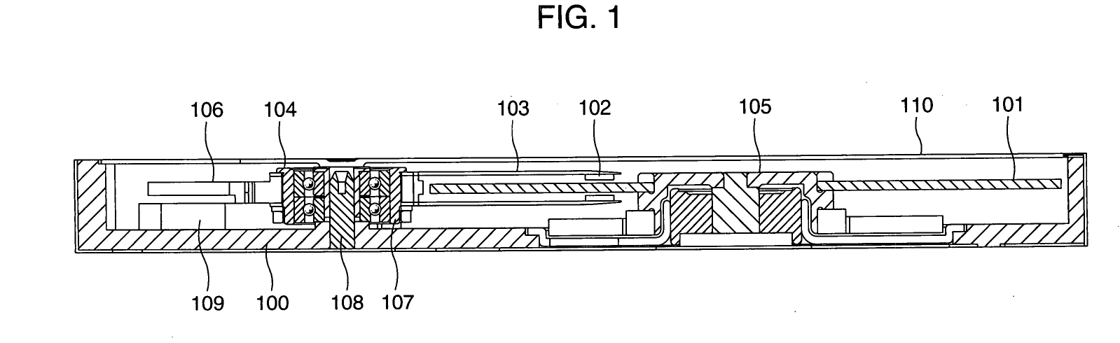

FIG. 1 is a cross sectional view showing an embodiment of a magnetic disc apparatus in accordance with the present invention. The magnetic disc apparatus is structured such that a spindle 105 is mounted on a base 100, and a magnetic disc 101 is mounted on the spindle. A magnetic head 102 is mounted to a suspension 103 and is mounted on a carriage 104.

The carriage 104 can rotate the magnetic head around a pivot 107 on the basis of an electromagnetic force of a VCM 109 generated by energizing a coil 106, and can position the magnetic head 102 to a predetermined track on the magnetic disc 101.

The magnetic disc apparatus is sealed by the base 100 and a cover 110 which form a part of the casing, whereby it is possible to prevent dusts from flowing therein from an outer portion.

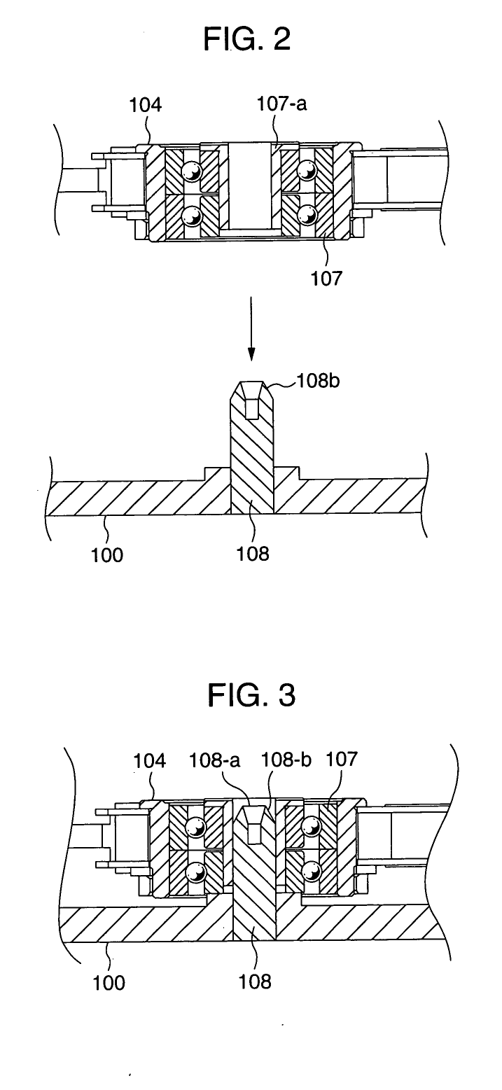

Describing in detail with using an enlarged view, as shown in FIG. 2, a pivot pin (refer simply as a shaft) 108 of a pivot mechanism 107 constituting the carriage 104 is press fitted to the base 100, and a pivot sleeve shaft (refer simply as a sleeve) 107-a of the pivot mechanism 107 is inserted to a pivot pin 108, and assembled. At this time, the pivot pin 108 has guide and positioning functions for assembly.

A taper portion 108-b is formed in a leading end portion of the pivot pin 108, and the leading end side is inserted to a through hole formed in the base 100 from an outer surface (a lower side in the drawing) of the base 100 toward an inner surface (an upper side in the drawing). The taper portion 108-b makes it easy to insert the pivot pin 108 to the through hole formed in the base 100.

It is possible to incorporate the pivot mechanism 107 corresponding to the constituting element of the carriage 104 by inserting the pivot pin 108 to the through hole of the pivot sleeve shaft 107-a in the pivot mechanism 107, and a state shown in FIG. 3 is established after the incorporation. At this time, the pivot pin 108 is easily inserted to the through hole of the pivot sleeve shaft 107-a by the taper portion 108-b of the pivot pin 108. In the case that the taper portion 108-b is provided in a side of the contact portion with the base 100 (in a side of a rear end of the pivot pin 108), a contact area and a contact length in an axial direction between the pivot pin 108 and the base 100 are reduced, so that it is disadvantageous in view of the strength and the slant prevention of the shaft. In accordance with the present embodiment, it is possible to provide a structure which has a high accuracy and a high reliability in view of the above points.

The pivot pin 108 and the pivot sleeve shaft 107-a are fixed by enlarging an outer diameter of the pivot pin 108 so as to press an outer peripheral surface of the pivot pin 108 against an inner peripheral surface of the pivot sleeve shaft 107-a to which the pivot pin 108 is inserted from a side of an axis (a center) of the pivot pin 108, in the state mentioned above.

In accordance with the present embodiment, a recessed hole portion 108-a of the pivot pin 108 is plastically deformed for fixing the pivot pin 108 and the pivot sleeve shaft 107-a.

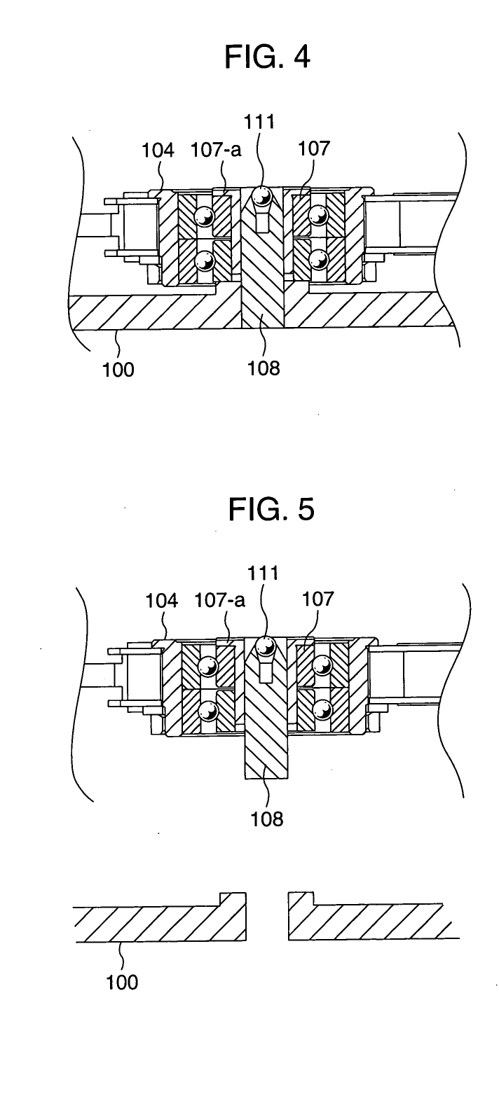

Further, as a means for plastically deforming the pivot pin 108, there is shown a method of press fitting a spherical member (a rigid ball in the present embodiment) 111 to the recessed hole 108-a portion of the pivot piston 108, in FIG. 4. The pivot pin 108 and the pivot sleeve shaft 107-a are fixed by press fitting the rigid ball 111 to the recessed hole 108-a portion after the carriage 104 is incorporated, so that the carriage 104 is rotatably fixed to the base 100.

Further, a description will be given of a method of replacing the magnetic head 102. In the case of the magnetic disc apparatus, there is more frequently generated a case that the magnetic disc 101 or the magnetic head 102 is replaced and reassembled due to an assembling state between the magnetic disc 101 and the magnetic head 102 or a defect in the assembling process or the like, in comparison with the other industrial products.

A description will be given of a method of replacing the head with reference to the drawing. At a time of replacing the magnetic head 102, the carriage 104 mounting the magnetic head 102 thereon is taken out from the base 100 by pushing out the carriage 104 in a direction of press fitting the pivot pin 108 to the base 100 together with the pivot pin 108 fixed in accordance with a plastic deformation at a time of assembling the carriage 104, as shown in FIG. 5. It is possible to separate the pivot pin 108 and the pivot pin sleeve shaft 107-a by receiving the pivot pin sleeve shaft 107-a and pushing out the pivot pin 108 from a lower side in FIG. 5 to an upper side, from the state mentioned above. Accordingly, the carriage 104 can be dissembled from the base 100, and the magnetic head 102 can be replaced. Further, the carriage 104 can be incorporated by press fitting the pivot pin 108 having a replaced head or arranged in another carriage 104, to the base 100. In the present embodiment, the head is replaced by separating the carriage from the base 100 together with the pivot pin 108.

It is easy to attach and detach the pivot pin 108 to and from the base 100, by using a resin base 100.

In a compact or thin magnetic disc apparatus, for example, a magnetic disc apparatus of 2.5 inch type, or a magnetic disc apparatus mounting a disc having a smaller size thereon, it is hard to secure a mounting space for mechanism members of a spindle portion and an actuator pivot portion, and most of the thickness of the magnetic disc apparatus is allocated for mounting the mechanism members, in the spindle and the actuator portion. In particular, in the magnetic disc apparatus having a thickness equal to or less than 5 mm, it is hard to secure a mounting space for the mechanism members of the spindle portion and the actuator pivot portion. Referring only to the actuator portion, it is a big problem for achieving a thin structure in the apparatus to fasten the pivot portion. In accordance with the embodiment mentioned above, since it is possible to fasten the pivot pin 108 and the pivot pin sleeve shaft 107-a in a state in which the member used for fastening (the rigid ball in the embodiment mentioned above) is received within the through hole of the pivot sleeve shaft 107-a, it is possible to inhibit the size of the apparatus in the direction of thickness from being increased in fastening the pivot portion.

On the other hand, there can be considered that the magnetic disc apparatus applied to an information appliance is a market need, on the basis of a breadth of the market of the magnetic disc apparatus. In the magnetic disc apparatus directed to the information appliance mentioned above, it is desired to make a produce while reducing a cost of the product. As a way of reducing the product cost, there can be considered a reduction in parts. In order to reduce the number of the parts, there can be considered a way of molding the base corresponding to the casing portion of the magnetic disc apparatus by a resin and mounting a circuit pattern. Accordingly, it is possible to integrally form the base, the circuit board and the connector mounted on the circuit board, and it is possible to design an apparatus in which the number of the parts is reduced and a space saving is achieved. However, in the case that the resin material is used in the base, a material strength is weaker than the metal material and a hardness is lower the metal material. Therefore, it is hard to make the structure thin, and there is a risk that a creep tends to be generated and a loose of thread is generated, so that a possibility is extremely low by the conventional structure in the mounting structure design of fastening the pivot portion. In accordance with the embodiment mentioned above, since the thread fastening force is not applied to the resin base at a time of fixing the pivot pin 108 or the pivot pin sleeve shaft 107-a to the base 100, the loose of thread due to the deformation of the resin and the creep is not generated, so that it is possible to achieve an assembly with a high reliability and a high accuracy.

Further, in the embodiment mentioned above, the reference surface for securing the coaxiality concerning the slant of the shaft and the displacement of the center is provided in the outer peripheral surface of the pivot pin 108 and the inner peripheral surface of the pivot sleeve shaft 107-a. In the case that the apparatus is made compact, the reference surface for preventing the slant of the shaft particularly in the concentricity can be advantageously made larger in the case that the reference surface is provided in the axial direction than the case that the reference surface is provided in the direction orthogonal to the axis. In the embodiment mentioned above, since the reference surface is formed along the axial direction of the pivot pin 108, it is possible to secure the reference surface large, so that it is possible to fasten the pivot pin 108 and the pivot pin sleeve shaft 107-a at a high accuracy while reducing the slant of the shaft. Further, the reference surfaces provided in the outer peripheral surface of the pivot pin 108 and in the inner peripheral surface of the pivot pin sleeve shaft 107-a constitute the reference surfaces for aligning the center in addition to preventing the slant of the shaft, so that the reference surfaces can be easily structured. Accordingly, it is possible to accurately position the carriage rotatably supporting the magnetic head, and it is possible to provide the magnetic disc apparatus which can be made compact and has a high reliability, and a method of assembling the same. Further, the magnetic head can be replaced by pulling out the pivot pin 108 from the base 100 so as to separate the carriage 104 from the base 100.

In accordance with the present invention, since it is possible to provide the structure which can maintain the coaxiality of the pivot portion in the carriage in a compact manner and at a high accuracy, it is possible to position the carriage at a high accuracy and it is possible to provide the magnetic disc apparatus which can be made compact and has a high reliability. Further, it is possible to replace the magnetic head by pulling out the shaft from the casing so as to separate the carriage from the casing.

It should be further understood by those skilled in the art that the foregoing description has been made on embodiments of the invention and that various changes and modifications may be made in the invention without departing from the spirit of the invention and the scope of the appended claims.

1. A magnetic disc apparatus comprising:
a rotated magnetic disc;
a magnetic head recording and reproducing an information-with respect to said magnetic disc;
a carriage supporting said magnetic head on said magnetic disc;
a pivot mechanism provided in said carriage; and
a casing supporting said pivot mechanism,
wherein said pivot mechanism comprises:
a shaft fixed to said casing;
a sleeve to which said shaft is inserted; and
a bearing rotatably supporting said magnetic head with respect to said sleeve, and
wherein said shaft and said sleeve are fixed to each other by pressing an outer peripheral surface of said shaft against an inner peripheral surface of said sleeve from a side of an axis of the shaft.

2. A magnetic disc apparatus as claimed in claim 1, wherein the outer peripheral surface of said shaft and the inner peripheral surface of said sleeve which are in contact with each other are formed by a smooth surface forming no thread.

3. A magnetic disc apparatus as claimed in claim 1, wherein a recess portion is formed in an end portion in an opposite side to a fixed portion of said shaft which is fixed to said casing, and an outer shape of said shaft is enlarged by inserting a member to said recess portion.

4. A magnetic disc apparatus as claimed in claim 1, wherein said casing is formed by a resin material.

5. A magnetic disc apparatus as claimed in claim 2, wherein said casing is formed by a resin material.

6. A magnetic disc apparatus as claimed in claim 3, wherein said casing is formed by a resin material.

7. A method of assembling a magnetic disc apparatus comprising:
a rotated magnetic disc;
a magnetic head recording and reproducing an information with respect to said magnetic disc;
a carriage supporting said magnetic head on said magnetic disc;
a pivot mechanism provided in said carriage; and
a casing supporting said pivot mechanism,
wherein the method comprises:
a step of press fitting a shaft provided in said pivot mechanism and having a taper and a recess portion formed in a leading end portion thereof to a through hole formed in said casing, from a side of said leading end portion;
a step of fitting a sleeve rotatably supporting the magnetic head by a bearing from said leading end side of said shaft; and
a step of fixing said shaft to said sleeve by pressing an outer peripheral surface of said shaft against an inner peripheral surface of said sleeve from a side of an axis of the shaft after fitting said sleeve to said shaft.

8. A method of assembling a magnetic disc apparatus as claimed in claim 7, further comprising a step of rotatably assembling said magnetic head in said sleeve before fitting said sleeve to said shaft.

9. A method of assembling a magnetic disc apparatus as claimed in claim 7, wherein said magnetic head is replaced by taking out said shaft from said casing in a state in which said magnetic head is assembled in said sleeve.

10. A method of assembling a magnetic disc apparatus as claimed in claim 7, wherein a casing formed by a resin material is used for said casing.

11. A method of assembling a magnetic disc apparatus as claimed in claim 8, wherein a casing formed by a resin material is used for said casing.

12. A method of assembling a magnetic disc apparatus as claimed in claim 9, wherein a casing formed by a resin material is used for said casing.
